(19) United States
(12) Patent Application Publication
(10) Pub. No.: US 2018/0375418 A1
(43) Pub. Date: Dec. 27, 2018

(54) MAGNETIC LEVITATION ELECTRICAL GENERATOR

(71) Applicant: Ryan Letts, Jamaica, NY (US)

(72) Inventor: Ryan Letts, Jamaica, NY (US)

(21) Appl. No.: 16/108,439

(22) Filed: Aug. 22, 2018

Related U.S. Application Data
(63) Continuation-in-part of application No. 14/814,600, filed on Jul. 31, 2015.
(60) Provisional application No. 62/031,878, filed on Aug. 1, 2014.

(51) Int. Cl. H02K 53/00

(52) U.S. Cl. CPC H02K 53/00; Y10S 74/09

(57) ABSTRACT

A device for generating an electric charge, having: a base; at last one capacitor; at least one magnet; a cover; a splitter; a load; a conductive core; a frictionless surface; and at least one discharge point. The at least one capacitor adapted and configured to store electricity generated from the electric charge. The splitter is adapted and configured to receive a first portion of electricity from the conductive core and divert a second portion of electricity back to the at least one capacitor and further divert a third portion of electricity to the load. The load is adapted and configured to store electricity and use a fraction of the total electricity generated by the device. The at least one magnet is adapted and configured to levitate and rotate on an electromagnetic rail around said conductive core in an infinite loop, wherein said rotation causes a magnetic field.

### CLAIM OF PRIORITY

This application is claim priority to U.S. patent application Ser. No. 14/814,600, filed Jul. 31, 2015, which claims priority to U.S. Provisional Patent Application Ser. No. 62/031,878 filed Aug. 1, 2014, the contents of which are hereby incorporated by reference herein in their entirety.

### FIELD OF THE EMBODIMENTS

The invention and its embodiments relate to a magnetic levitation electricity generating device.

### BACKGROUND OF THE EMBODIMENTS

Magnetic Levitation (or as it is also known Maglev) Power Generation is the process of electricity generation created by producing a magnetic field that rotates around a conductor like gold, silver, copper etc. The rotating magnetic field around the conductor produces electricity which flows through the conductor to power another device. A portion of the electricity produced will be syphoned back to a capacitor bank to keep the magnetic field energized. The magnetic field is rotated on a magnetically levitated surface to produce a constant motion and output at any speed.

Known previous in the art is:

International Publication No. WO2007021206 discloses a magnetic levitated transport system comprising a magnetic levitation guideway, and a magnetic levitation vehicle traversing said magnetic levitation guideway; said magnetic levitation guideway being defined by a pair of continuous parallel vehicle levitation guideways, each having a plurality of spaced apart rotating passive magnetic disc assemblies, a linear guideway electric generators interconnecting said passive magnetic disc assemblies, and a ferromagnetic attractive propulsion guideway disposed co-extensive with said magnetic levitation guideway; and said magnetic levitation vehicle being defined by a vehicle body, a magnetic suspension stabilizer disposed at the lower opposing sides of said vehicle body, including a plurality of electromagnetic array spinning discs spacedly disposed in a linear pattern thereof and in levitating communication with said magnetic disc assemblies, and a plurality of spaced apart pairs of magnetic propulsion wheel assemblies disposed linearly at the middle bottom portion of said vehicle body, each having a conical wheel defined by a conically shaped plurality of electromagnets angularity disposed thereof wherein at least a surface attractively communication with said ferromagnetic attractive propulsion guideway.

U.S. Pat. No. 7,462,950 teaches a magnetic levitation weight reduction structure for a vertical wind turbine generator includes a frame, a fixed permanent magnet, an axle, a revolving permanent magnet, a blade hub, and a generator. The fixed permanent magnet fixed to the frame has a first repulsive surface. The axle is connected to the frame. The revolving permanent magnet fixed to the axle has a second repulsive surface in relation to the first repulsive surface of the fixed permanent magnet. Both the first and the second repulsive surfaces repel with each other. The blade hub and the generator are connected to the axle. When the revolving permanent magnet is rotated, the axle functions as a balance center.

U.S. Publication No. 20130266429 discloses a turbine assembly which includes a split venturi shroud with two halves in hinged engagement about a vertical hinge axis that bisects the venturi shroud, a split clam jacket with two halves each attached to one of the two halves of the venturi shroud, and a rotor ring including an outer rim and a plurality of propeller blades within the outer rim. The rotor ring and venturi shroud are a rotor and a stator, respectively, of the turbine assembly. The venturi shroud is mountable on a support structure by transitioning from a folded state to an unfolded state. The clam jacket is open when the venturi shroud is folded and closed when the venturi shroud is unfolded, at least a portion of the support structure is surrounded by the clam jacket when in the unfolded state. The rotor ring can be mounted on the venturi shroud.

International Publication No. WO2009074128 discloses a maglev railway comprising a support and drive system of the long stator-linear motor type, magnetic support poles that are situated in the vehicle being additionally provided with linear generator windings (10) that generate electric energy in the vehicle. The aim of the invention is to prevent unwanted, periodic vibrations (ripples) from being generated at low speeds. To achieve this, according to the invention, the teeth (5) and grooves (6) of the long stator (3) are arranged ire high-speed sections (2a) parallel to the cores and the linear generator windings (10) of the support magnets provided in said cores and in low-speed sections (2b) obliquely to said cores (7) and linear generator windings.

U.S. Pat. No. 8,829,742 teaches a high efficiency permanent magnet machine capable of maintaining high power density. The machine is operable over a wide range of power output. The improved efficiency is due in part to copper wires with a current density lower than traditional designs and larger permanent magnets coupled with a large air gap. In a certain embodiment wide stator teeth are used to provide additional improved efficiency through significantly reducing magnetic saturation resulting in lower current. The machine also has a much smaller torque angle than that in traditional design at rated load and thus has a higher overload handling capability and improved efficiency. In addition, when the machine is used as a motor, an adaptive phase lag compensation scheme helps the sensorless field oriented control (FOC) scheme to perform more accurately.

U.S. Pat. No. 8,664,824 (and similarly U.S. Pat. No. 8,183,731 and U.S. Pat. No. 8,513,849) teaches a Halbach array which is radially disposed in an environment optimized for efficiency and controlled for efficient generation and use of power in order to generate, establish, and maintain a desired level of rotational energy with enhanced efficiency and in order to make the most efficient use of electromotive forces and magnetic fields which are either intentionally created for the operation of the apparatus or which result from the operation of the apparatus.

Various devices are known in the art. However, their structure and means of operation are substantially different from the present invention. Such devices fail to provide a device that is powered by a capacitor bank and not powered by a battery or chemical power. Such devices also contain many moving parts and therefore there is a need for a device that uses less energy and thus a larger energy output by having only one moving part and one conductive core. At least one embodiment of this invention is presented in the drawings below, and will be described in more detail herein.

### SUMMARY OF THE EMBODIMENTS

The present invention comprises a device for generating an electric charge, comprising: a base; at least one capacitor; at least one magnet; a cover; a splitter; a load; a conductive core; a frictionless surface; and at least one discharge point. The at least one capacitor adapted and configured to store electricity generated from the electric charge. The splitter is adapted and configured to receive a first portion of electricity from the conductive core and divert a second portion of electricity back to the at least one capacitor and further divert a third portion of electricity to the load. The load is adapted and configured to store electricity and use a fraction of the total electricity generated by the device. The conductive core is positioned on the frictionless surface. Then at least one magnet is adapted and configured to levitate and rotate on an electromagnetic rail around said conductive core in an infinite loop, wherein said rotation causes a magnetic field. The magnetic field is sustained by the at least one magnet and enables the electric charge to be perpetual. Then at least one discharge point is external to said device and energy is distributed to the external at least one discharge point.

Electricity is released from at least one capacitor in series or in parallel to the electromagnets. The at least one magnet may be comprised of neodymium. The conductive core may comprised of a copper, gold, silver coil or disc. The conductive core is affixed to at least one magnet and to the base of the unit. At least one magnet is comprised of at least one electromagnetic rail which spins in parallel.

The present invention also teaches a method for generating an electric charge, the steps comprising: rotating and levitating of at least one magnet on an electromagnetic rail around a conductive core in an infinite loop; wherein said rotation causing a magnetic field such that an electric charge is generated; storing the electric charge in at least one capacitor; receiving a first portion of the electric charge by a splitter; diverting a second portion of the electric charge back to the at least one capacitor; and further diverting a third portion of the electric charge to a load; using by the load a fraction of the total electric charge generated by the device; and storing by the load the remainder of the total electric charge generated.

It is an object of the present invention that the device comprises only one moving part.

It is an object of the present invention wherein the device generates an uninterrupted electrical current as long as device is powered and the at least one magnet is rotating.

It is an object of the present invention wherein the device requires no lubrication.

### BRIEF DESCRIPTION OF THE DRAWINGS

FIG. 1 is a perspective illustrative view of the present invention.

FIG. 2 is an alternative illustrative view of the present invention.

FIG. 3 is an alternative illustrative view of the present invention.

FIG. 4 is schematic view of the flow of electricity of the present invention.

FIG. 5 is an alternative schematic view of the flow of electricity of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

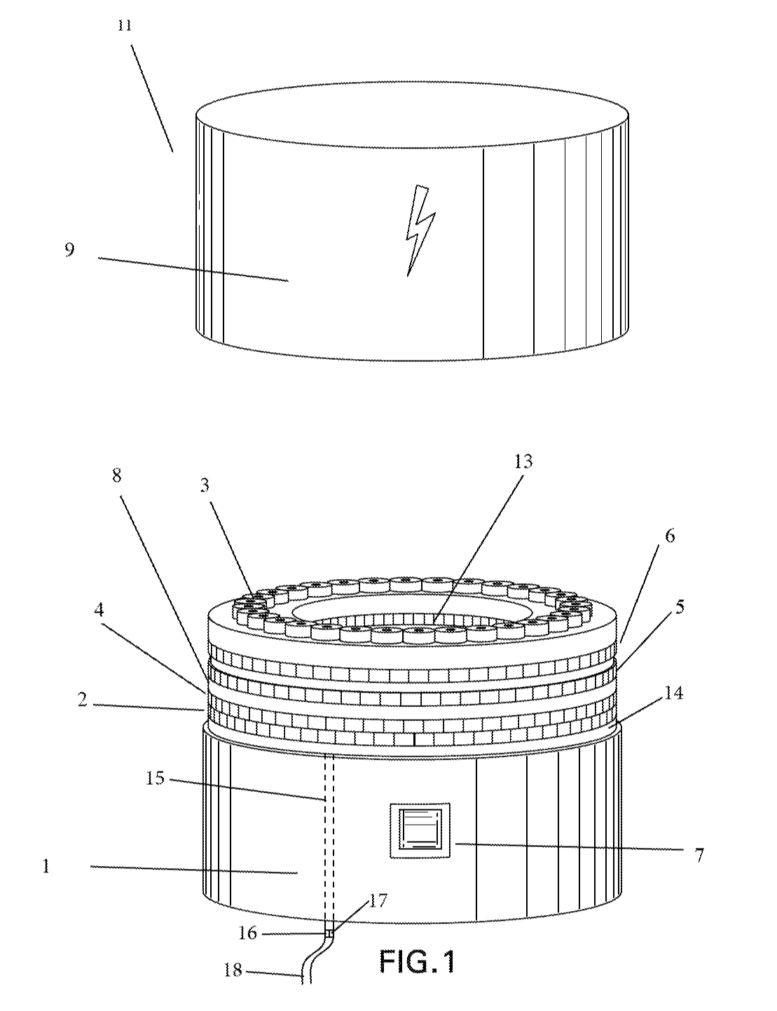

FIG. 1 is a perspective illustrative view of the present invention, a magnetic levitation electrical generator device 11. The device 11 comprises a base 1 and a cover 9. The base 1 and the cover 9 may be made of various nonmagnetic materials so as not to disrupt the magnetic forces of the generator. Such nonmagnetic materials may include rubber, plastic, stainless steel, feather, paper, mica, gold, silver, or leather. The base includes a manual power switch 7 which may be used to turn on or power the device off. The base 1 and cover 9 may be of various shapes and sizes. In a preferred embodiment, the base 1 and cover 9 are cylindrical or round in shape. The cover 9 is adapted and configured to cover the components of the device 11 that are secured to the base 1. In a preferred embodiment, the external diameter of the device is 10 inches and the height is 8 inches. In another embodiment the diameter can be larger or smaller depending on the device in which the invention is powering. The cover 9 or head moves around the conductive core. In a preferred embodiment of the invention, the base 1 and the cover 9 may be connected by a twist groove mechanism, screws or other securing mechanisms.

FIG. 1 also shows the components of the device 11. The device is comprised of a magnetic levitation bottom rail 2 and a magnetic levitation top rail 4. The rails are connected via magnetic force. The rails may spin and rotate in one direction or the top rail 4 may spin and rotate in an opposite direction than the bottom rail. In a preferred embodiment, the bottom rail is affixed and does not move) 2. The device 11 contains a conductive core 8 which is positioned on a frictionless surface 13. (The conductive core is affixed to the base). Positioned above the conductive core 8 is a bottom portion of magnets 5 and a top portion of magnets 6. The magnets may be comprised of neodymium or any natural magnets. In another embodiment, the magnets of the device 11 may be comprised of ferromagnetic material such as iron, nickel, cobalt, alnico (an aluminum-nickel-cobalt alloy). The bottom magnets 5 and the top magnets 6 also spin and rotate to create a magnetic field. The magnetic field creates electrical charges and currents. The generated electrical charge and current is captured by the capacitors which are positioned above the neodymium magnetic bottom 5 and magnetic top 6. The capacitors store electricity generated from the electric charge.

In a preferred embodiment, there is at least one capacitor. In another embodiment, there are a plurality of capacitors which are connected to each in a shape corresponding to or complimentary to the magnetic rails. Regardless of the amount of capacitors 3, they act as a bank to store electricity generated by the device. In a preferred embodiment, there is at least one magnet. In another embodiment, there are a plurality of magnets which are connected to one another by magnetic forces or which have been soldered together. The shape of the magnetic rails may correspond and compliment the shape and number of capacitors 3. However, this is not a requirement of the device.

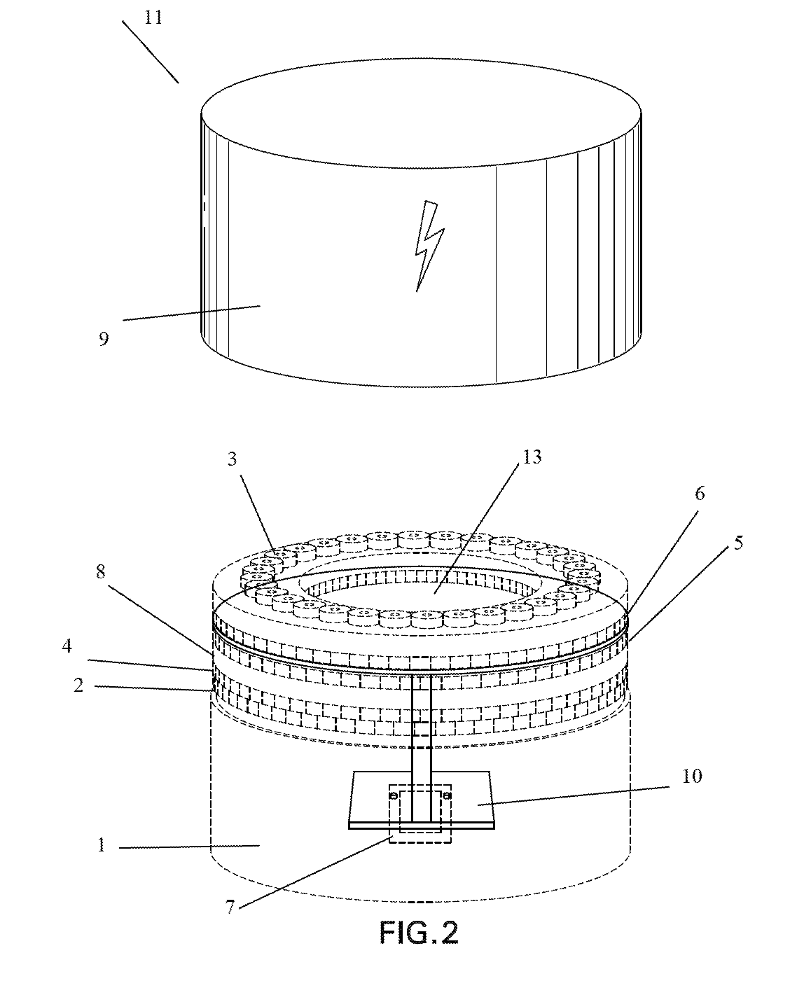

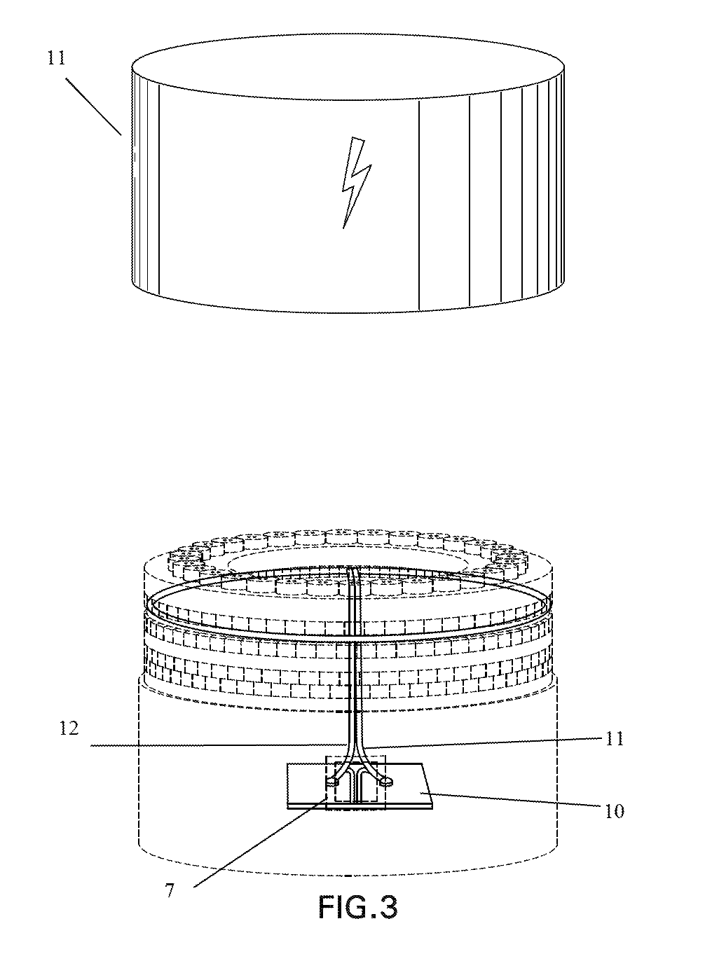

FIG. 2 shows the device 11. A base plate 10 secures a positive lead 11 and a negative lead 12 (the electrical polarity as shown in FIG. 3) which carries the electrical charge and current created by the rotating and levitation magnets. According to an embodiment, the device is capable of generating electricity on its own without a need for an outside current. According to an embodiment, an initial current from an outside source 18 flows through the device to aid the device in initially generating electricity. This initial current causes the magnets of the device to rotate, causing the device to generate its own current. According to an embodiment, once the device generates its own current, the initial current can be removed. According to an embodiment, once the device generates its own current, the device produces electricity that can be stored and/or used to power one or more devices.

According to an embodiment, the initial current originates from a device separate and apart from the device. According to an embodiment, the initial current originates from a capacitor 3 and/or a capacitor bank. According to an embodiment, the initial current provides enough power to the device to enable lift and rotation of the magnets, enabling the device to generate its own electricity. According to an embodiment, when the electromagnets are supplied with a sufficient amount of electric current, the magnets provide lift and rotation for the head, which houses one or more permanent magnets. According to an embodiment, the permanent magnets and the electromagnets are spaced far enough apart to enable the magnetic fields that they generate to not interact with each other. According to an embodiment, power flows through the stator 14, generating the magnetic field that causes rotation.

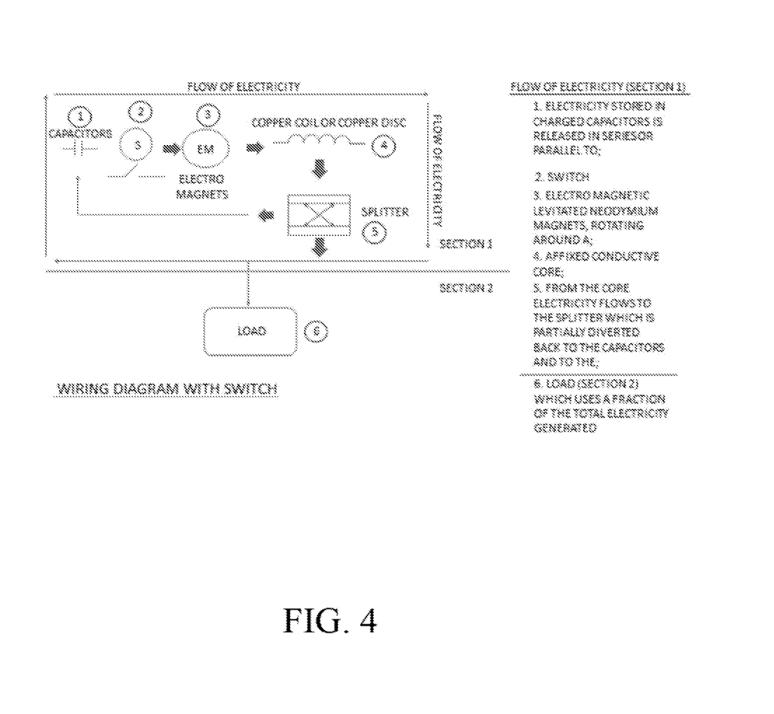

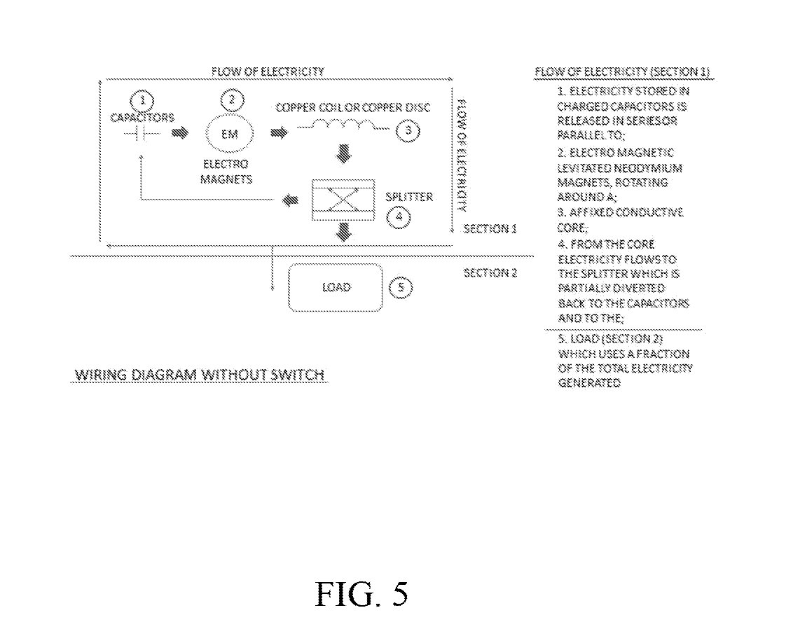

FIG. 4 is schematic view of the flow of electricity throughout the present invention. 1^{st}, as indicated by Step1 1, electricity is stored in the capacitors and released in a series or parallel to the electromagnetic rails. Electricity is then released to a Switch in Step 2. The switch may be manually or remotely open or close the circuit to turn the device on or off. IN Step 3, electricity powers the electromagnetic levitated Neodymium magnets which rotate around an affixed conductive core (Step 4). According to an embodiment, the Neodymium magnets (or other types of suitable magnets) may rotate in either direction, as long as the magnets have alternating polarities. From the conductive core, electricity flows to a splitter. The splitter may partially divert electricity back to the capacitors to start the electrical circuit again and to the Load (not shown). The Load uses a fraction of the total electricity generated by the elector magnetic levitated neodymium magnets. In another embodiment, the flow of electricity may not include a switch (as shown in FIG. 5) to turn the device on or off.

The present invention provides an electricity producing generator with only one moving part. The generator combines maglev technology with scalable output to deliver a constant amount of electricity as long as the device is turned on. Once the device is activated it can operate without interruption indefinitely and since the only moving part on the device is magnetically levitated there is no need for lubrication. The device delivers clean reliable renewable energy without any emissions and can be applied to virtually any device, vehicle or structure. An electric charge can be sustained in a magnetic field in an infinite loop to sustain the charge and distribute some energy to an external discharge point or points. The magnetic field is sustained by rotating magnets around a conductive core on a frictionless surface produced by magnetic levitation.

The magnets are electromagnetic magnets and may also include full-permanent magnets. This includes magnets 5 and 6. The full-permanent magnet and are comprised of neodymium (“rare earth”) magnets so that there is no energy loss through friction. Such magnets help reduce maintenance costs and increases the lifespan of the generator. According to an embodiment, the full-permanent magnets are arranged in alternating polarities. The magnetic field that the full-permanent magnets generate interacts with the coil. When the full-permanent magnets rotate, the gaps in the coil cause a break in the magnetic field which enables the generation of electricity. According to an embodiment, this generated electricity is collated by a stator 14 and travels down a shaft 15 to positive 16 and negative 17 terminals. According to an embodiment, the stator 14 is affixed to the base 7 of the device. According to an embodiment, the device includes the shaft 15 for transporting the electricity from the shaft to the positive 16 and negative 17 terminals. According to an embodiment, initial power is sent through the shaft 15 to the device to provide an initial current to initialize rotation of the discs. According to an embodiment, the initial power is provided by a capacitor or capacitor bank. It is noted, however, that other means of providing the initial power may also be used, while maintaining the spirit of the present invention.

While this disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Therefore, it is intended that the disclosure not be limited to the particular embodiments disclosed.

What is claimed is:

1. A device for generating an electric charge, comprising:
a base;
at least one capacitor;
at least one magnet;
a cover;
a splitter;
a load;
a conductive core;
a frictionless surface;
at least one discharge point; wherein
said at least one capacitor adapted and configured to store electricity generated from the electric charge;
said splitter adapted and configured to receive a first portion of electricity from the conductive core and divert a second portion of electricity back to the at least one capacitor and further divert a third portion of electricity to the load;
said load adapted and configured to store electricity and use a fraction of the total electricity generated by the device;
said conductive core positioned on the frictionless surface;
said at least one magnet adapted and configured to levitate and rotate on an electromagnetic rail around said conductive core in an infinite loop, wherein said rotation causing a magnetic field; wherein said magnetic field is sustained by the at least one magnet and enabling the electric charge to be perpetual as long as device is powered and the at least one magnet is rotating; and
said at least one discharge point external to said device and wherein energy is distributed to the external at least one discharge point.

2. The device of claim 1 wherein electricity is released from the at least one capacitor in series or in parallel to the electromagnetic rail.

3. The device of claim 1 wherein the at least one magnet is comprised of neodymium.

4. The device of claim 1 wherein the conductive core is comprised of a copper coil or a copper disc.

5. The device of claim 1, wherein the conductive core is affixed to the at least one magnet and to the base.

6. The device of claim 1, wherein the at least one magnet is comprised of at least one electromagnetic rail which spins in opposing directions.

7. A method for generating an electric charge, the steps of which comprising;
rotating and levitating of at least one magnet on an electromagnetic rail around a conductive core in an infinite loop; wherein said rotation causing a magnetic field such that an electric charge is generated;
storing the electric charge in at least one capacitor;
receiving a first portion of the electric charge by a splitter;
diverting a second portion of the electric charge back to the at least one capacitor;
and further diverting a third portion of the electric charge to a load;
using by the load a fraction of the total electric charge generated by the device; and
storing by the load the remainder of the total electric charge generated.

8. The method of claim 7 wherein electricity is released from the at least one capacitor in series or in parallel to the electromagnetic rail.

9. The method of claim 7 wherein the at least one magnet is comprised of neodymium.

10. The method of claim 7 wherein the conductive core is comprised of a copper coil or a copper disc.

11. The method of claim 7, wherein the conductive core is affixed to the at least one magnet and to the base.

12. The method of claim 7, wherein the at least one magnet is comprised of at least one electromagnetic rail which spins in opposing directions.

13. A device for generating an electric charge, comprising:
a base;
at least one capacitor;
at least one magnet;
a cover;
a load;
a conductive core;
a frictionless surface;
at least one discharge point; wherein
said at least one capacitor adapted and configured to store electricity generated from the electric charge;
said load adapted and configured to store electricity and use a fraction of the total electricity generated by the device;
said conductive core positioned on the frictionless surface;
said at least one magnet adapted and configured to levitate and rotate around said conductive core in an infinite loop, wherein said rotation causing a magnetic field; wherein said magnetic field is sustained by the at least one magnet and enabling the electric charge to be perpetual as long as device is powered and the at least one magnet is rotating; and
said at least one discharge point external to said device and wherein energy is distributed to the external at least one discharge point.

14. The device of claim 13, wherein electricity is released from the at least one capacitor in series or in parallel to the electromagnetic rail.

15. The device of claim 13, wherein the at least one magnet is comprised of neodymium.

16. The device of claim 13, wherein the conductive core is comprised of a copper coil or a copper disc.

17. The device of claim 13, wherein the conductive core is affixed to the at least one magnet and to the base.

18. The device of claim 13, wherein the at least one magnet is comprised of at least one electromagnetic rail which spins in opposing directions.

19. The device of claim 13, wherein the device generates an uninterrupted electrical current as long as device is powered and the at least one magnet is rotating.

20. The device of claim 13, wherein the device requires no lubrication.
